(19) United States
(12) Patent Application Publication
(10) Pub. No.: US 2021/0035179 A1
(43) Pub. Date: Feb. 4, 2021

(54) Cloud Infrastructure as Visualization Modeling

(71) Applicant: Prashant Shyamsundar Mishra, Redmond, WA (US)

(72) Inventor: Prashant Shyamsundar Mishra, Redmond, WA (US)

(21) Appl. No.: 16/529,864

(22) Filed: Aug. 2, 2019

(51) Int. Cl. G06Q 30/06; G06Q 30/02; G06Q 10/06; H04L 29/08; G06F 3/0484; G06F 3/0482

(52) U.S. Cl. CPC G06Q 30/0629; G06Q 30/0605; G06Q 30/0641; G06F 3/0482; G06Q 10/067; H04L 67/10; G06F 3/04847; G06Q 30/0205

(57) ABSTRACT

This tool provides an idea about which can be the probable infrastructure on cloud for any client. The visualization of cloud infrastructure gives the clear-cut picture to the client about which cloud is providing which kind of different cloud services available in specific regions at which costings. This tool provides information about all possible options to the client for upgrading & migrating to cloud in the best possible way, which eventually is a great thing as a customer to take the appropriate decision about cloud selection.

### FIELD

This document relates to the creative idea for providing the visualization as infrastructure on cloud per the technical need of the individual & organizational to design and deploy the same in the cost-effective manner.

### BACKGROUND

In any generations, communication plays a very vital role in society. When it comes to individual person, small organizations or big corporations for interaction with opposite person communication is very necessary. In the present era, cloud becomes the heart of all communication. Infrastructure plays the very important role in establishing the connection between any party, same applies to the cloud as well. In cloud, depending upon the end user then it may be individual, small organizations or big corporations we must design & deploy the necessary infrastructure as per the need and features demanded by the end user.

Visualization as Infrastructure is consisting of cloud, Networks, end users and connections between them which provides an idea to the end user to view the available options to take needed decision for the customized infrastructure as per their need.

The visualization as Infrastructure gives an idea to an end user as a probable infrastructure to create the connection with the cloud. This idea consider reliability, availability, security, administrator, visibility, geographical location, cost, performance, efficient so that end user can take the suitable customized decision as per their need.

The Inventor of the Visualization as Infrastructure has been involved with cloud infrastructure in a professional manner over a decade. He thinks there is a need of probable overview about the visualization as architecture which provides the detailed information to the end user for taking a decision before deploying a cloud infrastructure.

### SUMMARY

Visualization as Infrastructure will be encouraged an end user to select the best customized cloud infrastructure from the available options. Once an end user specifies their requirements, they will get a customized infrastructure on cloud.

The visualization as infrastructure's idea allows the end user to think and decide about the probable customized infrastructure which can be created and deployed based on certain parameter's evaluation like, 1. Distance, 2. Cost, 3. Number of terminals, 4. Security & Reliability, 5. Performance, 6. Diverse Support System, 7. Service Administration, 8. Realtime Service Management. 9. Reliability & Availability, 10. Security, 11. Data Center Administration, 12. Realtime Visibility and Reporting Capabilities.

Physical distance in infrastructure plays a vital role, as latency is one of the limiting factors as it is directly depending on physical distance between data centers and end users. This is the only thing which determines where infrastructure should be created & deployed

Cost is always one of the concern components for any end users. As per the need of the end users in terms of number of servers, routers, controllers, terminals, virtual machine and their costings.

Since cloud architectures uses shared resources, it must to provide a security on every aspect of operational architecture & process like only authorized users must get access to the system. In this shared platform data & application must be secure, this kind of trust every end user must get. If any failure occurs in any one or more components, the data must remain intact in virtual data center, the cloud needs to be able to continue to operate. The system should provide such kind of reliability & availability to the end users.

Performance is also one of the prime components to look for cloud because this is the only thing which will tells which cloud is better than the other. Infrastructure influences the performance in a few ways. The need of certain number of virtual machines or terminals needed to be in the network. Along with this bandwidth and latency offered by the cloud is also measurable factor.

There are many types of components comes under features such as whether system is diverse in nature or not. The diverse system gives a leverage to the user for using the latest hardware, virtualization and software solutions, with data center's existing infrastructure.

System administrator makes sure about the services that end users must get which includes resource guarantees, metering rules, resource management and billing cycles, these services should be quickly & easily deployed for smooth functionality.

The system must have the ability to create policies around workload and data management to ensure that maximum efficiency & performance is delivered to the end users specially in peak demand conditions in real time scenario.

System must be able to integrate with traditional as well with modern cloud management solutions. All the interfaces need to be interchangeable to developers and third parties through common APIs.

Keep checking the systems from a performance, service level point of view to ensure security, billing, compliances as well others which requires high levels real time visibility and reporting capabilities.

In order to deliver highly reliable, highly scalable services to the end users in more agile & cost-effective manner system should be capable of interfacing to administrative, developer & end user.

The Visualization as Infrastructure compares different cloud providers based on the weightage given to different parameters like cost, performance, security, distance, number of terminals etc. The user selects the required parameters with respective weightage.

In the following scenario where the user selects three parameters like, cost, feature and distance then the comparison would be based on weightage given on it.
For Example
The weightage given to Cost parameter is 5 out of 10
The weightage given to Feature parameter is 3 out of 10
The weightage given to Distance parameter is 2 out of 10
Please find below the matrix of the Visualization as Infrastructure per the example.

| Sr. No. | Parameters | Weightage |
|---|---|---|
| 1 | Geographical area | 2 |
| 2 | Cost | 5 |
| 3 | Features | 3 |

| | |
|---|---|
| Total | 10 |

User defines weightage on different cloud parameter; suppose for cost 5 is allotted out of 10, foe feature 3 is allotted out of 10 and for geographical area 2 is allotted out of 10. On this given combination of weightage by user cloud provider will suggest desired cloud.
For Example
In a scenario where the user selects only one parameter then the comparison would be based 10 of that parameters. Like if the user chooses only cost as the parameter for comparison between the technology, then the ranking would be based 10 on the costs. On the other hand, if the user selects multiple parameters then the comparison would be based on the weightage of the selected parameters being compared.
If the user chooses cost and geographical area as the parameters for comparison between cloud provider, then the ranking would be based 60% on cost and 40% on performance as per the weightage of the component & likewise.
Infrastructure technology is ranked for the parameters selected by the user based on the weightage assigned to each of them. These weightages are identified with respect to the importance of components as determined by the user.

### BRIEF DESCRIPTION OF DRAWINGS

FIG. 1 illustrates flow chart of Visualization as infrastructure on cloud.

FIG. 2 illustrates block diagram of Visualization as infrastructure on cloud.

FIG. 3 illustrates functional diagram of Visualization as infrastructure on cloud.

FIG. 4 illustrates table describes example showing three clouds with their attributes.

FIG. 5 illustrate compute service offers for a selected cloud.

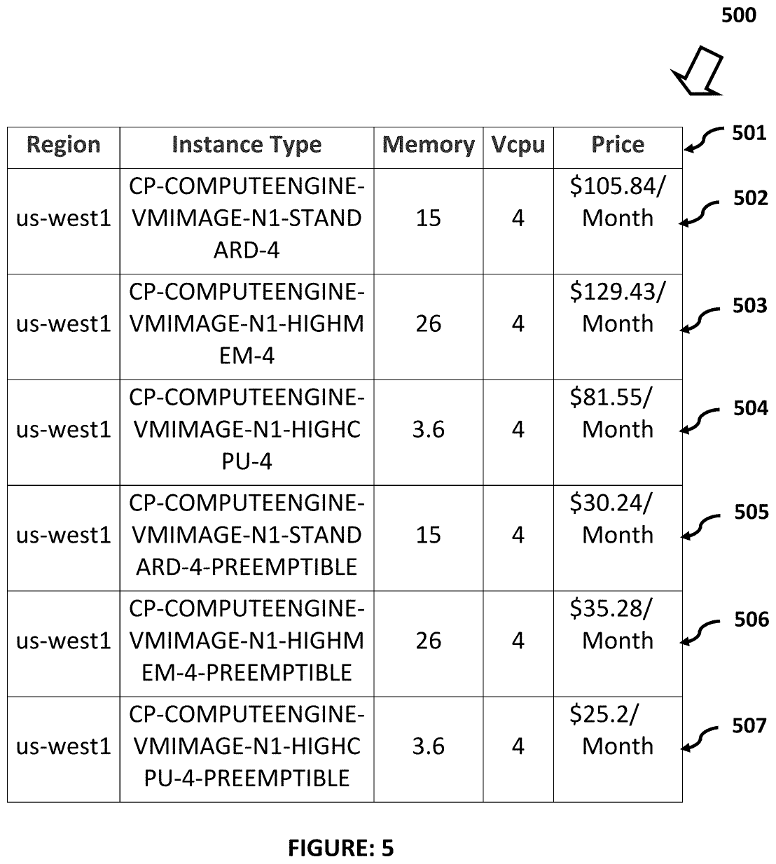

FIG. 6 illustrate Network service offers for a selected cloud.

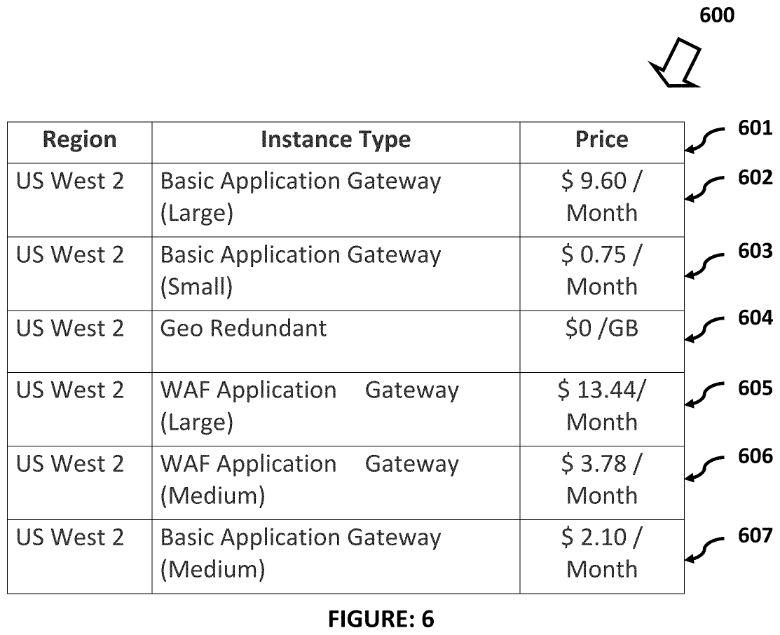

FIG. 7 illustrate storage service offers for a selected cloud.

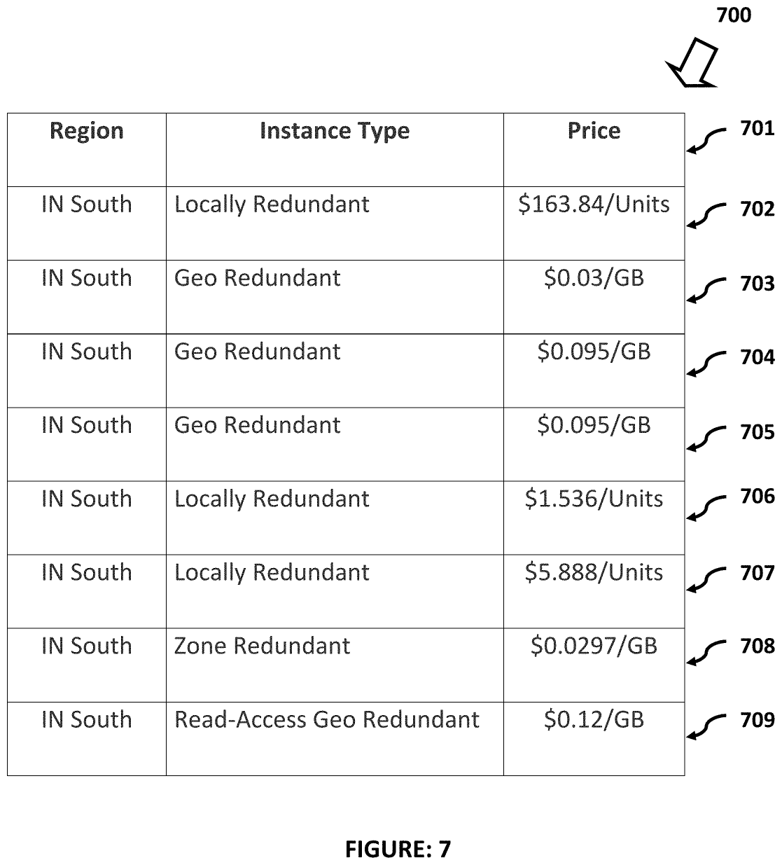

FIG. 8 illustrate UI of Tool for Visualization as Infrastructure.

### DETAIL DESCRIPTION

The subject matter described in this specification is related to the visualization of infrastructure. Cloud infrastructure is the combination of software and hardware. The main components of infrastructure are compute, storage, virtual servers. Virtual private cloud, virtual network switches/hubs/router, virtual storage cluster, virtual memory and virtualization software. All these elements combine to create complete IT infrastructure on cloud on cloud.

Infrastructure as a service is a cloud model which provide IT infrastructure components on rent to an organization such as computing, storage and networking over the internet.

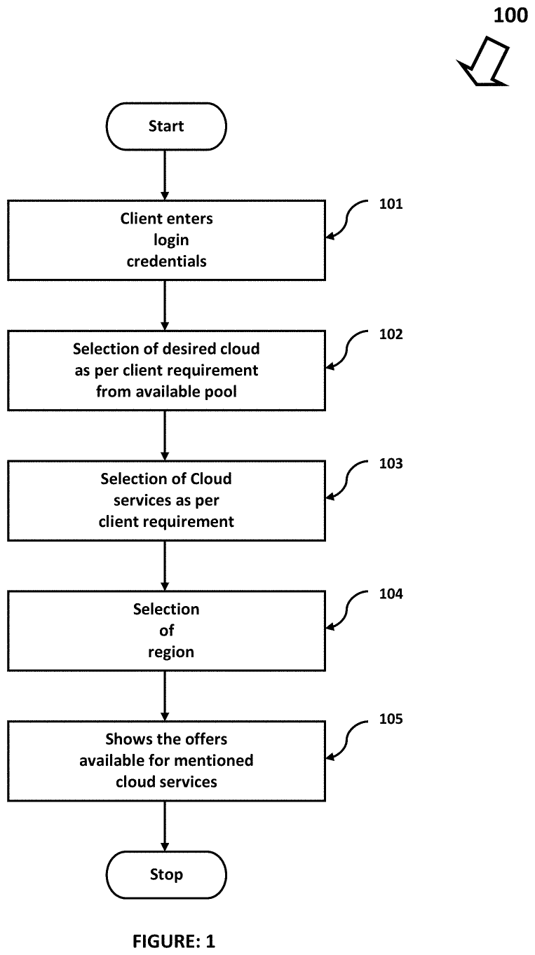

FIG. 1 is flow chart 100 of visualization as infrastructure, different steps have been mentioned. Client will enter his login credentials 101 to log in the tool, which provides the different available cloud's information.

Client will select 102 the desired cloud as per his requirement from the available pool of clouds. After selection of particular cloud, client will select the desired cloud services 103. And specific region 104.

After submitting all parameters cloud compare tool will shows the available offers for mentioned parameters. From those available options clients will select one of them.

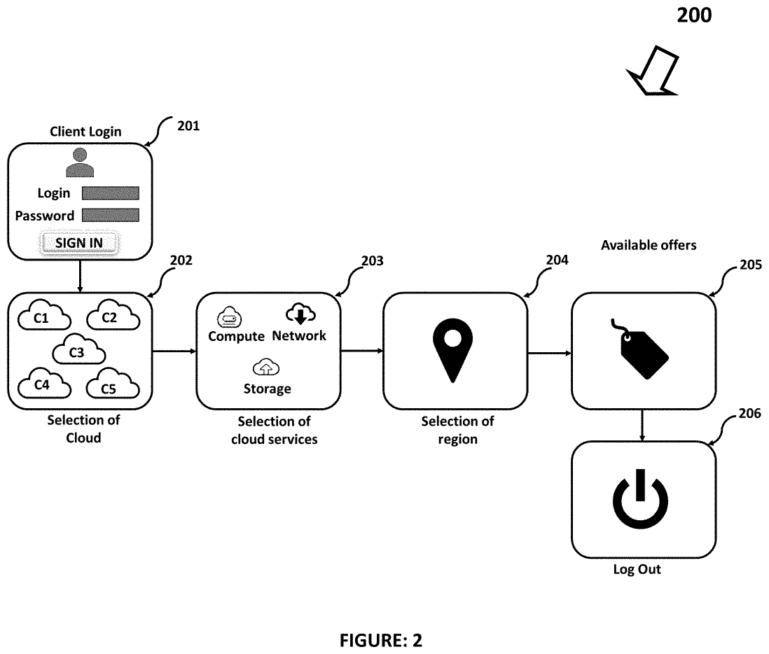

FIG. 2 illustrates block diagram of cloud infrastructure 200. The main components of this block diagram are client login 201, selection of cloud 202, selection of cloud services 203, selection of region 204, shows available offers 205, RAM, log out 205.

In client login 201, existing user will enter login ID and password or if client is new, he will register with new registration. After entering the credentials customer will be able to see pool of clouds with their features. According to the requirement of client and features of the cloud, client will select particular cloud 202.

After selection of cloud 202, client will select cloud services 203 like compute, network, storage etc. and then selects the region 204 and submit all this information, cloud compare will compare all these parameters and will present available offers 205 in a selected cloud.

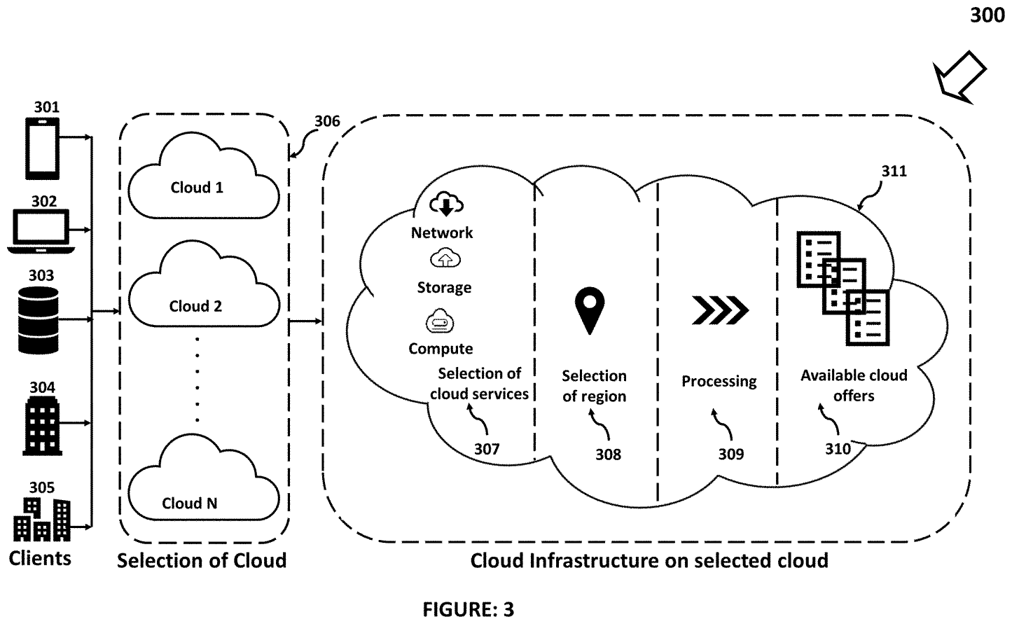

FIG. 3 illustrate functional block diagram of cloud infrastructure 300. This functional block diagram has mainly comprised of four types of clients individual 301-302, database 303, small scale business 304 and large-scale business 305, selection of cloud 306 and cloud infrastructure 311. Client may be mobile user 301, laptop302, database 303, small unit business 304, large scale business 305.

Client will login into the site 201, after login client will find the available cloud providers with their attributes like cost, features and geographical area. From this given information client will select the suitable cloud 306.

After selection of cloud, client will create virtual private cloud 307. Virtual private cloud is a virtual network dedicated to client cloud account. It will isolate from other virtual networks on cloud. A virtual private cloud user can define and directly manage network components, including IP addresses, subnets, network gateways and access control policies.

Later on the client will select required cloud services 307 and selects the region 308. With these selected parameters cloud compare tool will compare the cloud will process 309 on it and provides available cloud offers 310. Combinedly all these processes create cloud infrastructure 311.

310 shows the available cloud service offers from different cloud providers which provides for example compute, storage, network etc.

System 300 gives a visualization of cloud infrastructure. Cloud infrastructure is consisting of software and hardware part. Practically on cloud infrastructure we will get instances for each client and network.

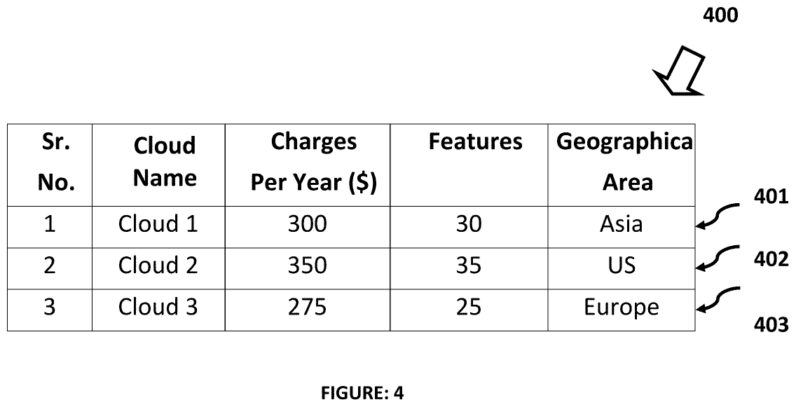

As illustrated in 300 selection of cloud based on cost, number of features provided by cloud providers and geographical area. Based on these parameters an example has been explained in FIG. 4 which is showing three cloud with their attributes.

In 401, cloud 1 has the charge per year is of $300, total number of features provided by cloud provider 1 is 30 and geographical area Asia. Another example has been illustrated in 402, cloud 2 has charge per year of $350, number features available is 35 and geographical rea is united states. Same for Cloud 3 given in 403.

In 500, table shows the offers available for compute service for parameters like region, Instance type, memory, Vcpu and price per month. For example, for selection of Vcpu=4 all the available offers on given cloud has shown from 502 to 507. Client will analyze given offers and then select whichever client wants.

In 600, table shows the offer available for network service. To see the different network service offers, first need to select the region. As per the selection of region available offers in selected clouds for region will show, from 602 to 607 are the examples of offers. From these offers, one will analyze the offers and select whichever client wants.

In 700, table shows the offers available of storage services for selected clouds. To see the available offers on selected cloud, client will select the region and as per the selected petameters cloud compare will compare it with database and will generate the storage regions with cost per GB. 701 to 709 are the examples of available offers for storage services for selected cloud.

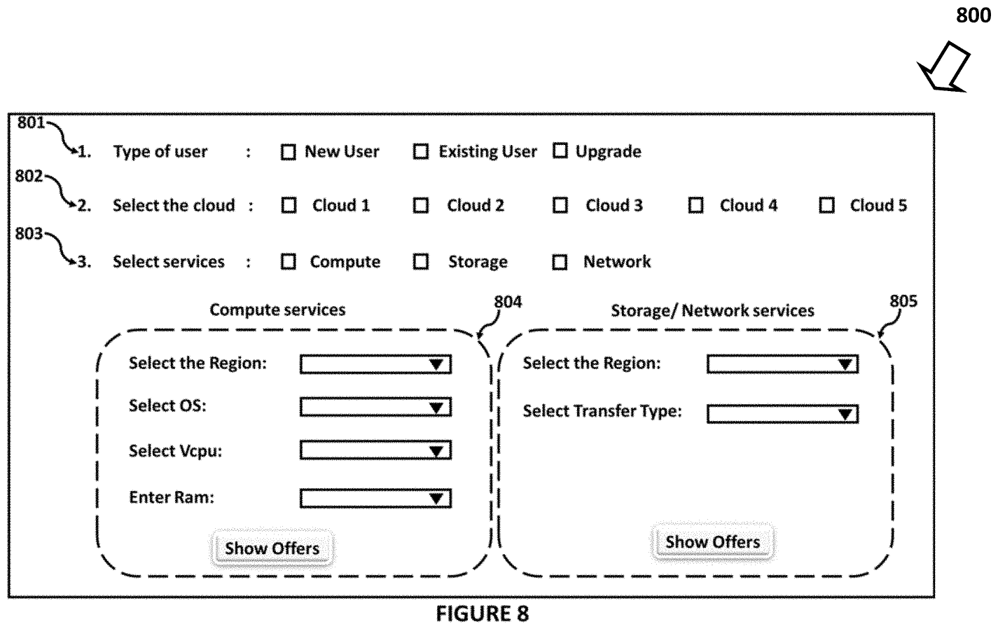

FIG. 8 is the UI tool for Visualization as Infrastructure 800. By using this tool client can see the various offers for different cloud services available. To know the offers, first client will have to select types of user 801. Type of user may be new user, existing user and upgrade.

New user will register himself on cloud, will use all cloud services. Existing users are those users, who already on one cloud but want shift on another cloud. If the client wants to migrate from on-premises to cloud, then such clients comes under upgrade category.

After selection of type of user, client will select the clouds 802 from the available clouds. And after that he will select services 803, for example compute, network and storage. If client selects compute services 804, he needs to enter region, operating system, Vcpu and RAM. Based on these parameters, cloud compare will filter the data and shows the available offers.

If client selects storage/network 805, then it requires to select the region and transfer type. Based on these selected parameters cloud compare tool will filter the result and shows available or filtered offers of network/storage.

From this given information client will make decision which cloud is suitable for him. From the filtered result client can analyze the things and can take decision for which cloud & with which offer he can go.

What is claimed is:

1. A method comprising, selection of type of users, selection of cloud, selection of cloud services; client is selecting cloud provider based on cost per year, number of features provided by cloud provider and the geographical area;

2. The method comprising, user interface tool which will take all requirements from client like types of user, select the cloud and selection of cloud services.

3. Cloud compare tool will compare the entered parameters with stored data records and will show all cloud offers.

4. The offers generated by this cloud compare tool will help the client to take decision, which cloud is good for them; and complete analysis can do based on region, OS, memory, Vcpu etc.

5. The main parameter is region is required to know the available cloud offers of cloud services.
By using this tool one can easily visualize an infrastructure on cloud.
